(19) United States
(12) Patent Application Publication
(10) Pub. No.: US 2018/0166801 A1
(43) Pub. Date: Jun. 14, 2018

(54) ELECTRICAL CONNECTOR

(71) Applicant: Ojun Electrical Co., Ltd., Foshan (CN)

(72) Inventor: Changxiong PAN, Beijing (CN)

(21) Appl. No.: 15/525,939

(22) PCT Filed: Mar. 30, 2016
(86) PCT No.: PCT/CN2016/077786

§ 371 Date: May 10, 2017

(51) Int. Cl. H01R 9/24; H01R 9/22; H01R 9/16; H01R 4/48

(52) U.S. Cl. CPC H01R 9/2416; H01R 4/48; H01R 9/16; H01R 9/223

(57) ABSTRACT

The present invention discloses an electrical connector, comprising: a first insulated shell and a second insulated shell; the first insulated shell has a first chamber and a second chamber opening towards one direction; the second insulated shell is detachably assembled in the first insulated shell; the second insulated shell is inlaid with the second conductive clamping sheet, and the second insulated shell is combined with the first insulated shell to enable the second conductive clamping sheet to contact with the contact tongue part elastically. The present invention has characteristics of simple structure, cost saving, fast assembly and disassembly, low manufacturing cost, good safety and not easily disengaged conductive clamping sheet, good closure of contact area and wide application.

### TECHNICAL FIELD

The present invention relates to an electrical connector.

### BACKGROUND OF THE PRESENT INVENTION

Electrical connector is an essential basic element of an electrical wiring system. Electric connection is carried out between devices, components and systems to be used to connect power line, control line and so on. As a basic element, the convenience and safety of use are particularly important. Generally, existing connectors have problems of bad separation of conducting wire, easy off-line of conducting wire, complicated structure due to assembly and disassembly in threading manner, so that production cost and use cost are higher.

We developed an electrical connector to overcome above problems.

### SUMMARY OF THE PRESENT INVENTION

The purpose of the present invention is to provide an electrical connector with characteristics of simple structure, cost saving, fast assembly and disassembly, low manufacturing cost, good safety and not easily disengaged conductive clamping sheet, good closure of contact area and wide application. Therefore, it is a product with excellent practicability, economy and technicality.

The present invention adopts following technical scheme to realize above purpose: an electrical connector, comprising a first insulated shell; the first insulated shell has a first chamber and a second chamber opening towards one direction; a first conductive clamping sheet is respectively provided in the first chamber and the second chamber;

a second insulated shell; the second insulated shell is detachably assembled in the first insulated shell.

The first chamber comprises a wiring chamber and a mating chamber communicated with the wiring chamber.

The first conductive clamping sheet comprises a wiring touch plate part, a contact tongue part connected and contacted with or formed on the wiring touch plate part; the wiring touch plate part is located in the wiring chamber; and the contact tongue part extends from the wiring chamber to the mating chamber; and the contact tongue part has a guiding bend.

The second insulated shell is inlaid with the second conductive clamping sheet, and the second insulated shell is combined with the first insulated shell to enable the second conductive clamping sheet to contact with the contact tongue part elastically.

In one or more embodiments of the present invention, the first conductive clamping sheet is provided with a clamping tongue part, the clamping tongue part is placed in the clamping groove, and the first conductive clamping sheet is limited to move outwardly by means of the convex platform.

In one or more embodiments of the present invention, the mating chamber is provided with a guiding plate; the second insulated shell is provided with an inserting part for inserting the mating chamber; the inserting part is provided with a guiding clearance groove; and the second insulated shell is combined with the first insulated shell to place the guiding plate in the guiding clearance groove.

In one or more embodiments of the present invention, the second insulated shell is locked in the first insulated shell by a limiting structure.

In one or more embodiments of the present invention, the limiting structure comprises protruding buckles provided on both sides of the inserting part and a recess provided in the mating chamber.

In one or more embodiments of the present invention, a cavity is formed by the contact tongue part and the wiring touch plate part; the guiding bend turns back to the cavity; the wiring touch plate part has a blocking plate, so that the guiding bend bends within a setting range.

In one or more embodiments of the present invention, the first insulated shell is an integrated structure made of plastic materials, the first insulated shell comprises a housing inlaid with the mating chamber and a wiring housing connected to the housing; the wiring housing is inlaid with the first chamber and the second chamber independent with each other, the wiring housing is higher than the housing, the housing is provided with a wiring label, and an upper plate of the wiring housing is provided with a reinforcing rib.

In one or more embodiments of the present invention, the inserting part has a first inserting arm and a second inserting arm, and both the first inserting arm and the second inserting arm have a T-shaped chamber.

In one or more embodiments of the present invention, a edge of the first inserting arm and the second inserting arm is provided with a rounded corner, and the guiding bend has a calibration slot.

In one or more embodiments of the present invention, the first conductive clamping sheet and the second conductive clamping sheet are symmetrically arranged; the first chamber is provided with an assembling lead-in groove, and the contact tongue part has a side clamp for fitting the assembling lead-in groove.

Compared with the prior art, the present invention has following beneficial effects:

The present invention adopts above technical scheme, and has characteristics of simple structure, cost saving, fast assembly and disassembly, low manufacturing cost, good safety and not easily disengaged conductive clamping sheet, good closure of contact area and wide application. Therefore, it is a product with excellent practicability, economy and technicality.

### BRIEF DESCRIPTION OF THE DRAWINGS

FIG. 1 is a structure diagram of an electrical connector of the embodiment according to the present invention.

FIG. 2 is a section view cut along A-A line in FIG. 1.

FIG. 3 is a section view cut along B-B line in FIG. 1.

FIG. 4 is an enlarged view of C in FIG. 2.

FIG. 5 is an expanded structure diagram of an electrical connector of the embodiment according to the present invention.

FIG. 6 is a fitting structure of a first conductive clamping sheet 2 and a second conductive clamping sheet 4 of an electrical connector of the embodiment according to the present invention.

FIG. 7 is an enlarged view of D in FIG. 5.

FIG. 8 is an enlarged view of E in FIG. 5.

### DETAILED DESCRIPTION OF THE PRESENT INVENTION

The embodiments of the present invention are described as follows in detail. The examples of embodiments are shown in figures, the same or similar reference mark means the same or similar element or the element with the same or similar function.

In the description, it needs to be explained the nouns of locality and terms like “center”, “horizontal”, “longitudinal”, “length”, “width”, “thickness”, “up”, “down”, “front”, “back”, “vertical”, “level”, “top”, “bottom”, “inside”, “outside”, “clockwise”, “counterclockwise” and other words indicating direction and position relationship are based on figures to describe the present invention and simplify the description, but not identify or imply the device or element must have specific direction, and the construction and operation with specific direction cannot be understood the limitation of the protection scope of the present invention.

Besides, the terms “the first” and “the second” are only for description purpose, but not identify or imply quantities of relative importance or technical features. Therefore, the feature with “the first” and “the second” can be understood as one or more features, in the description, “at least” means one or more than one, unless otherwise specified.

In the present invention, unless otherwise specified, the terms “assembly”, “ communication” and “connection” should be understood the broad meaning, for example, the connection can be fixedly connection, detachably connection, integrally connection or mechanically connection; the communication can be direct communication, communication through intermediation, and also it can be internal communication between two elements. The meaning of above terms in the present invention can be understood based on the situation for those skilled in the art.

In the present invention, unless otherwise specified and provided, if the first feature is above or below the second feature, it contains direct contact between the first feature and the second feature and also contact through other features between the first feature and the second feature. Moreover, if the first feature is above the second feature, it contains the first feature is right above and inclined top of the second feature, or it just means the level of the first feature is higher than that of the second feature. If the first feature is below the second feature, it contains the first feature is right below and inclined underneath of the second feature, or it just means the level of the first feature is lower than that of the second feature.

The preferred embodiments of the present invention are further described in combination with drawings of description, so that the technical scheme and beneficial effects are more clear and definite. The embodiments are illustrative for explaining the present invention, but not the limitation of the present invention.

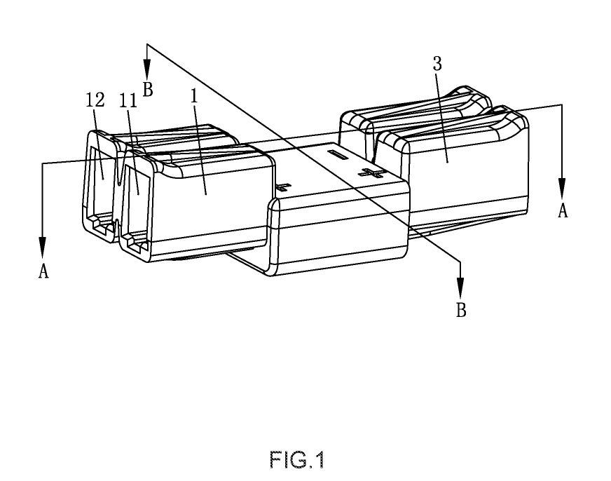

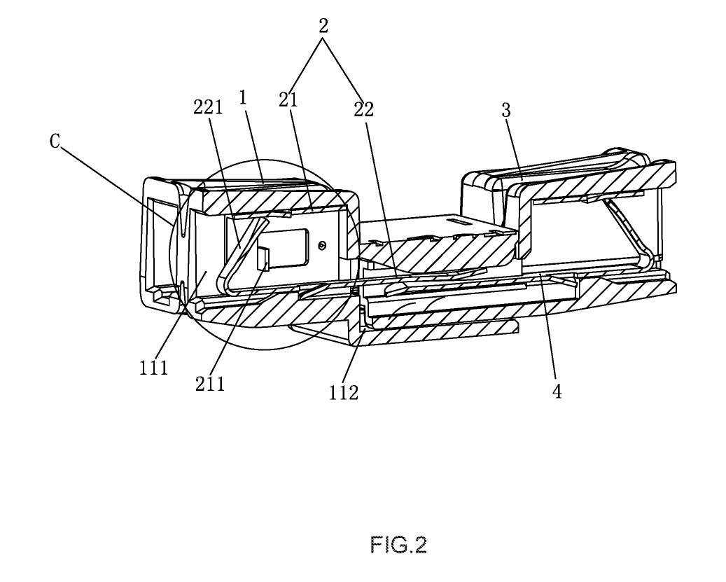

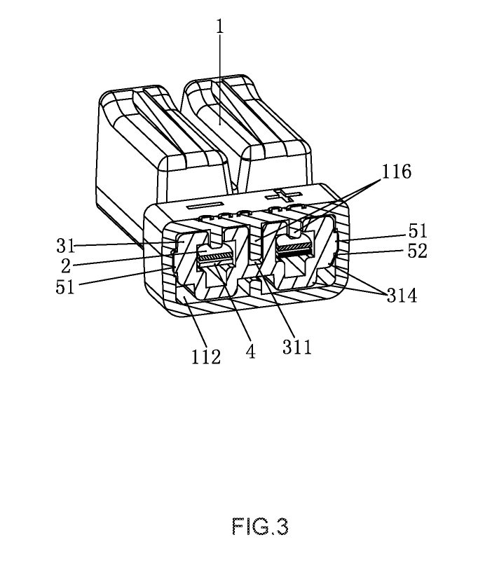

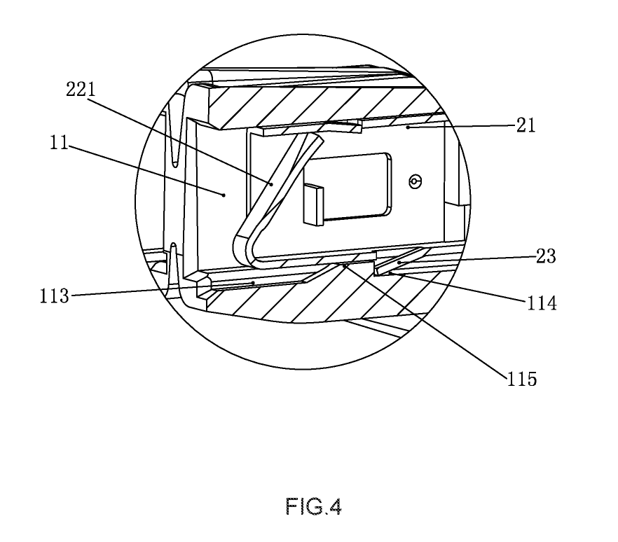

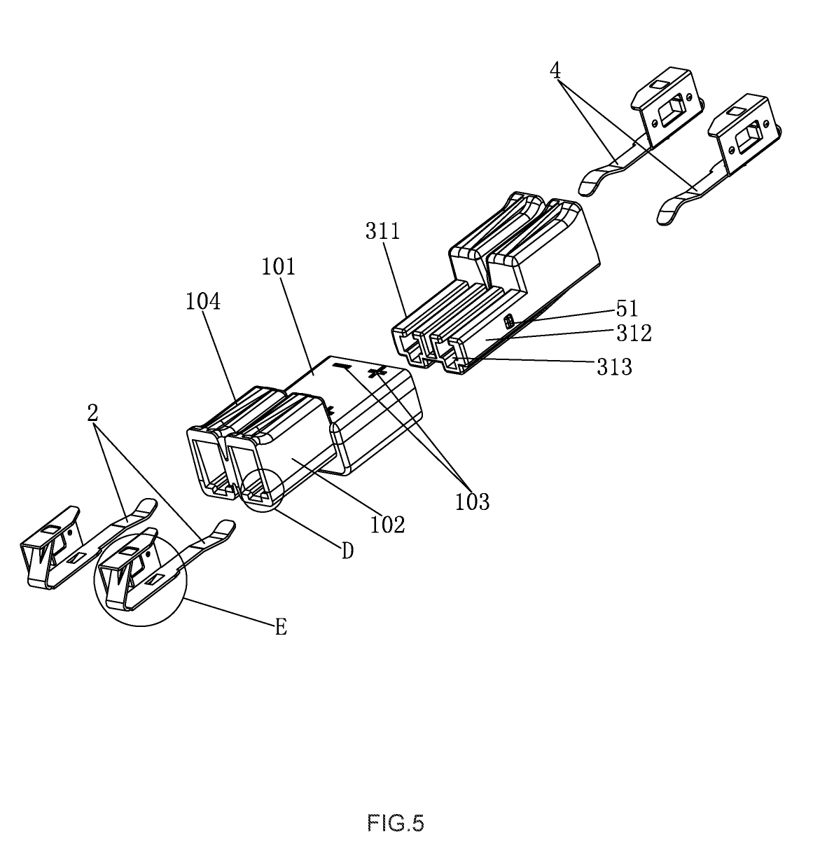

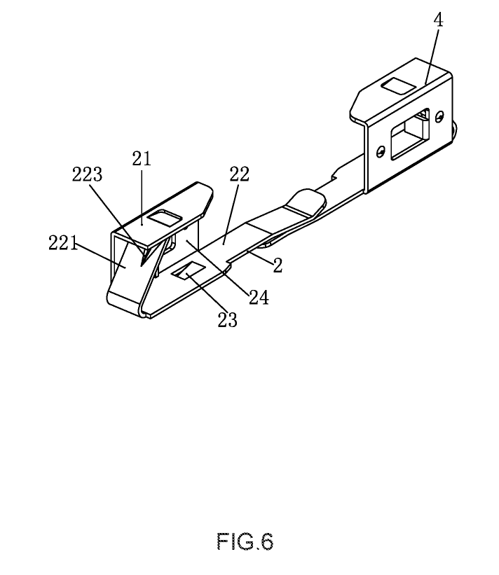

As shown in FIG. 1-FIG. 6, the present invention provided a preferred electrical connector, comprising

a first insulated shell 1, a first conductive clamping sheet 2, a second insulated shell 3 and a second conductive clamping sheet 4; the first insulated shell 1 has a first chamber 11 and a second chamber 12 opening towards one direction; a first conductive clamping sheet 2 is respectively provided in the first chamber 11 and the second chamber 12.

The second insulated shell 2 is detachably assembled in the first insulated shell 1.

The first chamber 11 comprises a wiring chamber 111 and a mating chamber 112 communicated with the wiring chamber 111.

The first conductive clamping sheet 2 comprises a wiring touch plate part 21, a contact tongue part 22 connected and contacted with or formed on the wiring touch plate part 21; the wiring touch plate part 21 is located in the wiring chamber 111; and the contact tongue part 22 extends from the wiring chamber 111 to the mating chamber 112; and the contact tongue part 22 has a guiding bend 221.

The own elasticity of the guiding bend 221 can form self-locking when connecting the wire, the conducting wire is not easily to be fall off, and the first conductive clamping sheet 2 laid in the first chamber 11 and the second chamber 12 makes the separation of the conducting wire bigger, which greatly increases the safety performance, and the operation of connecting wire is very convenient and rapid.

The second insulated shell 3 is inlaid with the second conductive clamping sheet 4, and the second insulated shell 3 is combined with the first insulated shell 1 to enable the second conductive clamping sheet 4 to contact with the contact tongue part 22 elastically. The conducting wire contacts firmly, has strong ability against external environment, can deal with problems like shake, swing and force pull. The second conductive clamping sheet 4 contacts with the contact tongue part 2 elastically, and the first insulated shell 1 and the second insulated shell 2 fit more tightly and not easily to fall off.

The first chamber 11 is provided with a lead-in groove 113, a clamping groove 114 and a convex platform 115 located between the lead-in groove 113 and the clamping groove 114; the first conductive clamping sheet 2 is provided with a clamping tongue part 23, the clamping tongue part 23 is placed in the clamping groove 114, and the first conductive clamping sheet 2 is limited to move outwardly by means of the convex platform 115. In this way, multidirectional structure is adopted to fit and optimize, the lead-in groove 113 greatly facilitates the assembly of the first conductive clamping sheet 2, and one action of the convex platform 115 is to rise the contact tongue part 22, so that the first conductive clamping sheet 2 fits more tightly inside the wiring chamber 111 under own volume or elasticity, and the other action of the convex platform 115 is to clamp the clamping tongue part 23, so that the first conductive clamping sheet 2 is limited to move outwardly. The mating chamber 112 is provided with a guiding plate 116; the second insulated shell 3 is provided with an inserting part 31 for inserting the mating chamber 112; the inserting part 31 is provided with a guiding clearance groove 311; and the second insulated shell 3 is combined with the first insulated shell 1 to place the guiding plate 116 in the guiding clearance groove 311.

The first insulated shell 1 and the second insulated shell are fitted tightly to achieve purpose of not easily to be fall off, the second insulated shell 3 is locked in the first insulated shell 1 by means of the limiting structure 5. The limiting structure 5 comprises protruding buckles 51 provided on both sides of the inserting part 31 and a recess 52 provided in the mating chamber 112. After assembly, the protruding buckles 51 are buckled in the recess 52 and form a locking state.

A cavity is formed by the contact tongue part 22 and the wiring touch plate part 21; the guiding bend 221 turns back to the cavity 24; the wiring touch plate part 21 has a blocking plate 211, so that the guiding bend 221 bends within a setting range. The guiding bend 221 is provided with a calibration slot 223. When the conducting wire is inserted to operate, the conducting wire enters into the calibration notch 223, so that the guiding bend 221 is forced to bend until the blocking plate 211, then the guiding bend 221 presses the conducting wire on the wiring touch plate part 21 to form self-locking. In this way, the conducting wire is not easily fall off, and the connect operation is very convenient and rapid. The first conductive clamping sheet 2 and the second conductive clamping sheet 4 are symmetrically arranged.

The first insulated shell 1 is an integrated structure made of plastic materials, the first insulated shell 101 comprises a housing 101 inlaid with the mating chamber and a wiring housing 102 connected to the housing 101; the wiring housing 102 is inlaid with the first chamber 11 and the second chamber 12 independent with each other, the wiring housing 102 is higher than the housing 101, the housing 101 is provided with a wiring label, and an upper plate of the wiring housing 102 is provided with a reinforcing rib. The production is easy, the structure is compact and firm, not easy to be deformed, the production efficiency is high and finished product ratio is high.

The inserting part 31 has a first inserting arm 311 and a second inserting arm 312, and both the first inserting arm 311 and the second inserting arm 312 have a T-shaped chamber 313. The edge of the first inserting arm 311 and the second inserting arm 312 are provided with a rounded corner 314. When assembly, the rounded corner 314 makes the inserting part 31 into the mating chamber 112 more successfully, so that the assembling operation difficulty is greatly decreased, and the assembly efficiency is greatly improved.

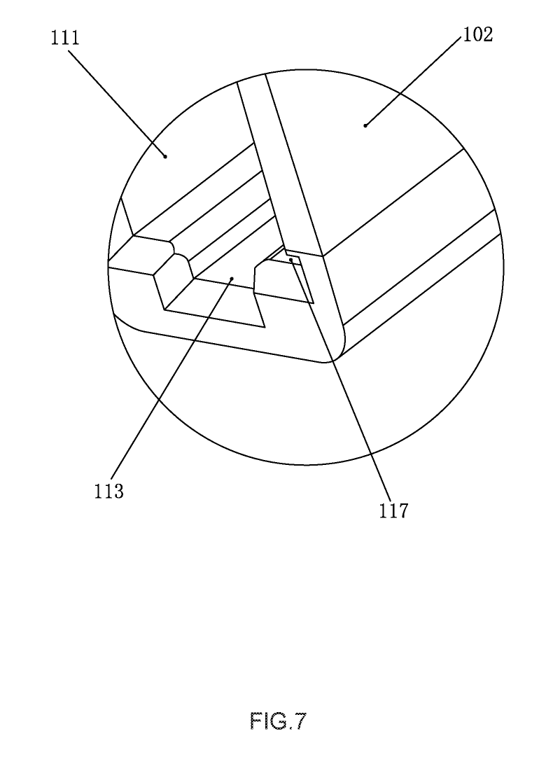

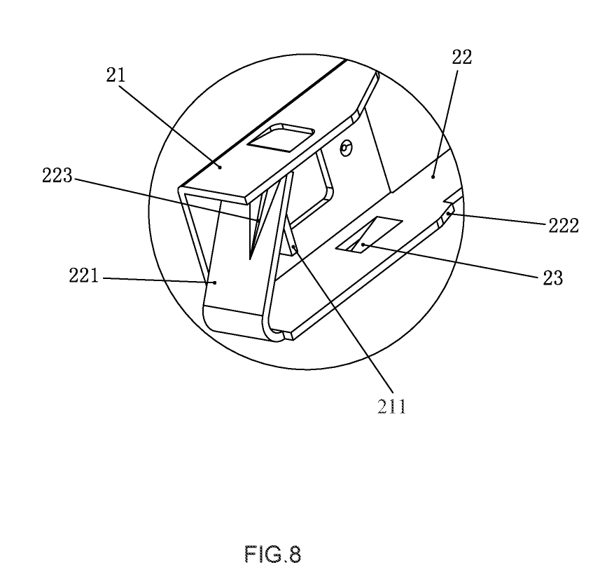

As shown in FIG. 7 and FIG. 8, the first chamber 11 of the first insulated shell 1 is provided with the assembling lead-in groove 117, and the contact tongue part 22 has a side clamp 222 for fitting the assembling lead-in groove 117. When assembly, the side clamp 222 is placed in the assembling lead-in groove 117, so that the first conductive clamping sheet 2 can be guiding assembled in the first insulated shell 1 smoothly, and the first conductive clamping sheet 2 can be kept to be free deformation.

In the description, the reference terms “one embodiment”, “preferably”, “example”, “concrete example” or “some examples” mean specific feature, structure, material or characteristics combined with the embodiment or example, contained in at least one embodiment or example in the present invention, and the schematic representation of above terms in the description is not always the same embodiment or example. Besides, the described specific feature, structure, material or characteristics can be combined in one or more embodiments or examples in proper manner.

Those skilled in the art shall understand the present invention is not limited to above embodiments based on the description of above structure and principle, any variations and replacements with well-known art of the art based on the present invention shall fall into the protection scope, and the protection scope shall be limited to claims.

What is claimed is:

1. An electrical connector, comprising:
a first insulated shell; wherein the first insulated shell has a first chamber and a second chamber opening towards one direction; a first conductive clamping sheet is respectively provided in the first chamber and the second chamber;
a second insulated shell; the second insulated shell is detachably assembled in the first insulated shell;
the first chamber comprises a wiring chamber and a mating chamber communicated with the wiring chamber;
the first conductive clamping sheet comprises a wiring touch plate part, a contact tongue part connected and contacted with or formed on the wiring touch plate part;
the wiring touch plate part is located in the wiring chamber; and the contact tongue part extends from the wiring chamber to the mating chamber; and the contact tongue part has a guiding bend;
the second insulated shell is inlaid with the second conductive clamping sheet, and the second insulated shell is combined with the first insulated shell to enable the second conductive clamping sheet to contact with the contact tongue part elastically.

2. The electrical connector according to claim 1, characterized in that the first chamber is provided with a lead-in groove, a clamping groove and a convex platform located between the lead-in groove and the clamping groove; the first conductive clamping sheet is provided with a clamping tongue part, the clamping tongue part is placed in the clamping groove, and the first conductive clamping sheet is limited to move outwardly by means of the convex platform.

3. The electrical connector according to claim 2, characterized in that the mating chamber is provided with a guiding plate; the second insulated shell is provided with an inserting part for inserting the mating chamber; the inserting part is provided with a guiding clearance groove; and the second insulated shell is combined with the first insulated shell to place the guiding plate in the guiding clearance groove.

4. The electrical connector according to claim 3, characterized in that the second insulated shell is locked in the first insulated shell by a limiting structure.

5. The electrical connector according to claim 4, characterized in that the limiting structure comprises protruding buckles provided on both sides of the inserting part and a recess provided in the mating chamber.

6. The electrical connector according to claim 1, characterized in that a cavity is formed by the contact tongue part and the wiring touch plate part; the guiding bend turns back to the cavity; the wiring touch plate part has a blocking plate, so that the guiding bend bends within a setting range.

7. The electrical connector according to claim 6, characterized in that the first insulated shell is an integrated structure made of plastic materials, the first insulated shell comprises a housing inlaid with the mating chamber and a wiring housing connected to the housing; the wiring housing is inlaid with the first chamber and the second chamber independent with each other, the wiring housing is higher than the housing, the housing is provided with a wiring label, and an upper plate of the wiring housing is provided with a reinforcing rib.

8. The electrical connector according to claim 7, characterized in that the inserting part has a first inserting arm and a second inserting arm, and both the first inserting arm and the second inserting arm have a T-shaped chamber.

9. The electrical connector according to claim 8, characterized in that a edge of the first inserting arm and the second inserting arm is provided with a rounded corner, and the guiding bend has a calibration slot.

10. The electrical connector according to claim 1, characterized in that the first conductive clamping sheet and the second conductive clamping sheet are symmetrically arranged; the first chamber is provided with an assembling lead-in groove, and the contact tongue part has a side clamp for fitting the assembling lead-in groove.
